(19) United States
(12) Patent Application Publication
(10) Pub. No.: US 2004/0153513 A1
(43) Pub. Date: Aug. 5, 2004

(54) Method for handling a message with multimedia reference

(76) Inventors: Josef Laumen, Hildesheim (DE); Andreas Schmidt, Braunschweig (DE); Markus Trauberg, Velchede (DE)

Correspondence Address: BELL, BOYD & LLOYD, LLC, P. O. BOX 1135, CHICAGO, IL, 60690-1135, US

(21) Appl. No.: 10/479,432

(22) PCT Filed: May 22, 2002
(86) PCT No.: PCT/DE02/01850

(30) Foreign Application Priority Data
Jun. 1, 2001 (DE) 101 26 847.5

(51) Int. Cl. G06F 15/16

(52) U.S. Cl. 709/206; 709/230

(57) ABSTRACT

The invention relates inter alia to a method for handling a message with a multimedia reference in a transmission application and/or transmission/reception application which is implemented on a mobile radio device or on a device which is connected to a mobile radio device. One aspect of the invention is essentially characterized in that the message is generated and transmitted in such a way that it comprises at least one reference contained in a co-transmitted specification block, said reference relating to at least one file which is stored in a memory outside the mobile radio device or on the device which is connected to the mobile radio device. The invention also relates to corresponding methods in a provider network element and corresponding devices and software programs.

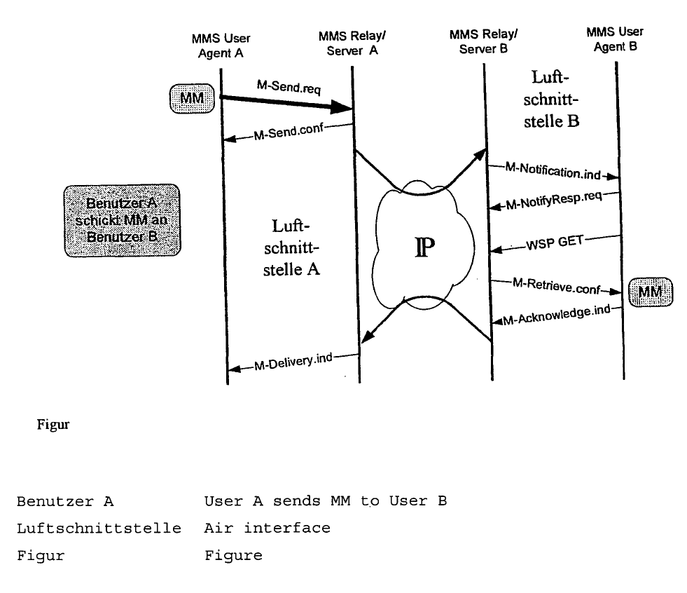

The invention relates to a method for handling a message with multimedia reference in a send application or send/receive application as well as in a provider network element.

The invention further relates to the corresponding facilities, software programs and a software program product. Mobile radio system GSM (GSM—Global System for Mobile Communications) offers both voice telephony and also the option of sending or receiving short text messages of up to 160 characters in length. This service is called SMS (SMS—Short Message Service), see GSM 03.40 Version 7.4.0, Release 1998, Digital Cellular Telecommunications System, Technical realisation of the Short Message Service (SMS). For the next-generation mobile radio system UMTS (UMTS—Universal Mobile Telecommunications System) there is currently a standardized multimedia-capable variant of a mobile messaging service, called MMS (Multimedia Messaging Service), see 3G TS 23.140 Version 4.1.0, Release 4, Third Generation Partnership Project, Technical Specification Group Terminals, Multimedia Messaging Service (MMS), Functional Description, Stage 2. To delimit them more clearly below from the text messages of the SMS system, messages with multimedia content will be referred to for short merely as MMs (MM—Multimedia Message). By contrast to SMS, such messages are not restricted simply to text content. With MMS it will be possible to format texts in accordance with individual taste as well as to embed audio and video content into a message.

According to the current prior art an implementation of MMS is only realized using WAP (WAP—Wireless Application Protocol). To bridge the air interface between a MMS-enabled terminal and the WAP gateway there is provision for the use of the WAP WSP Transfer Protocol, see 3G TS 23.140 Version 4.1.0 (see above) and WAP-209-MMSEncapsulation, Release 2000; Wireless Application Protocol) WAP Multimedia Messaging Service; Message Encapsulation; WS Proposed SCD 1.0.

The single Figure shows a Transaction Flow Diagram according to the prior art as per WAP-209-MMSEncapsulation (see above) in which the exchange of the MMS messages between the four entities involved (MMS User Agent A, MMS Relay/Server A, MMS Relay/Server B and MMS User Agent B) is illustrated for the transmission of an MM. MMS User Agent can be seen as an application, on a mobile terminal for example, or on a device connected to a mobile terminal (e.g. laptop or similar) which realizes MMS. An MMS Relay/Server is a network element at the MMS Service Provider which provides the MMS User Agents with MMS functionality.

The Figure shows a known application of the exchange of WAP messages (“MMS User Agent A sends an MM to MMS User Agent B”) in accordance with the prior art. The MM generated in MMS User Agent A is sent with the WAP message M-Send.req to MMS Relay/Server A. MMS User Agent A then receives the WAP message M-Send.conf in return, with which the correct receipt of the MM from MMS Relay/Server A is confirmed. The MM is forwarded from the send-side MMS Relay/Server A and the receive-side MMS Relay/Server B via SMTP (SMTP—Simple Mail Transfer Protocol), e.g. by the Internet (IP—Internet Protocol). MMS Relay/Server B then informs MMS User Agent B with WAP message M-Notification.ind about the resources (URI—Universal Resource Identifier) of the newly arrived MM which is ready for downloading. MMS Relay/Server B then receives, e.g. with WAP message M-NotifyResp.req a confirmation that the notification (M-Notification.ind) about the MM which has arrived has been successfully issued. MMS User Agent B then uses WAP message WSP GET, with which the URI is sent to the MMS Relay/Server B, to request delivery of the MM. With WAP message M-Retrieve.conf the desired MM is then issued to MMS User Agent B by MMS Relay/Server B. MMS User Agent B acknowledges correct receipt of the MM with WAP message M-Acknowledge.ind. For the case in which the sender has expressed the desire to be informed about a successful receipt of the MM sent by them, MMS Relay/Server A can achieve this by sending the WAP message M-Delivery.ind to MMS User Agent A.

If a sender of an MM wishes to integrate a file into an MM, this file must be stored on the terminal. If the file is not stored in the database, the sender can download the desired file before the MM is sent via the air interface of an MMS Service Provider for example with knowledge of the corresponding URI, then incorporate it into his MM and subsequently send the complete MM. This MM has then grown by the size of the appended file. One disadvantage here is the time expended, another is the high costs arising for transmission over the expensive air interface.

The object of the invention is to implement a simplification of the handling of MMs in relation to the files to be incorporated.

This object is achieved with the features in accordance with claims 1, 8, 14, 17, 18 or 19.

The invention relates to both the creation and sending of a message with the reference in accordance with the invention by a send application (MMS User Agent A) as well as the receipt and the processing of this message by the intermediate send and receive-side MMS Relay/Server A and B or MMS Service Provider A and B (which can be identical in each case). At the same time the invention records activities on the send/receive application side (MMS User Agent B) which is informed about a message sent in this way and for its part can request a selected action in the form of a message about the receive-side MMS Relay/Server. Likewise the corresponding software programs on the individual devices are a component of this invention. In particular these devices feature the necessary processors, control units and also send and/or receive facilities in each case.

An important characteristic of the invention is to give the sender of an MM the opportunity to save themselves the download described above of the MM element present in the form of a file onto their mobile radio device or onto the equipment connected to the mobile radio device (e.g. laptop). Instead the user is given the option, by means of a control unit assigned to the device or connected to it, of specifying in their MM at least one reference in the specification block to at least one file, preferably in the form of a URI (resource). The URI of the file here is naturally a part of the MM other than that sent in accordance with the prior art. It is thus possible in particular to append the at least one file only after the transmission of the MM over the air interface (shown as air interface A in the figure) in the area of responsibility of the MMS Service Provider, known as the MMSE (MMSE—Multimedia Messaging Service Environment), to the part of the MM sent according to the prior art. Further transmission of the complete MM including the appended file is preferably undertaken according to the prior art. This method has the twin advantages of an enormous reduction of the volume of data on the send-side air interface and the associated cost savings: One is when—if the file has not yet been stored on the send application—instead of the desired file, the sender only downloads its URI, and the other is during sending of the MM itself, since the entire selected file is not a component of the MM, but only its URI which is a few bytes in length. A further advantage is that, according to this invention, MMS User Agent A itself can send as MM elements those data types (e.g. pictures) and file formats (e.g. JPEG) which it is not itself in a position to display or reproduce.

A requirement for implementing the idea described above is the option of being able to specify a URI (memory address) for the file when sending an MM. This is preferably achieved by a modification in the specification block of the WAP message M-Send.req with which the message with the multimedia reference is sent. In this case the reference part of the specification block is thus the WAP message M-Send.req. This WAP message is therefore highlighted in bold in the WAP MMS Transaction Flow Diagram in the figure.

In the example below in accordance with this embodiment of the invention user A (Andreas xxx) would like to use MM to send birthday greetings to user B (Markus yyy). The MM, which initially only consists of a text, is composed in MMS User Agent A. User A also wants to integrate a birthday melody into the MMS. Since he doesn't currently have an appropriate melody stored on his terminal, he decides to contact his MMS Service Provider (by mobile Web browsing for example) and select one of the melodies that they offer. in accordance with the invention user A need only download the URI (of a few bytes in size) instead of the entire audio data (of typically a few kilobytes in size) onto his MMS User Agent A and integrate the latter into his MM.

Preferably a new header field is introduced for this integration, which could for example be designated “X-Ms-Add-Element”. The field name bears the hexadecimal value 0x89 for example. The field values are preferably coded in accordance with WAP-209-MMSEncapsulation (see above) as a text string. The coding of the newly-defined header field then appears as follows:

X-Ms-Add-Element: (0x89)

Add-Element-Value=Text-String

The WAP message M Send.req according to the example given above then appears as follows.

M-Send.req (MMS User Agent A-->MMS Relay/Server A):

X-Mms-Message-Type: m-send-req

X-Ms-Transaction-ID: TRANSACTION-ID#L

X-Mms-Version: 1.0

Date: Wed, 28 Feb. 2001 10:44:11+0100

From: andreas!xxx@xxx.de

To: markus.yyyzzz.de

Subject: Birthday greetings

X-Mms-Delivery-Report: Yes

X-Ms-Add-Element:

http://provider_a.de/attachments/melody65 Content-Type: Application/vnd.wap.multipart.mixed

nEntries: 1

HeadersLen: XX

DataLen: XX

Content-Type: text/plain;

Hello Markus,

Here is a little tune to wish you all the best for your birthday.

All the best, Andreas.

The birthday MM can then be sent. As well as the text it also contains the resource indicator (URI) in the header field “X-Mms-Add-Element” the desired audio file in the area of responsibility of the MMS Service Provider and is thus far smaller than an MM composed of the text and audio file itself.

After error-free transmission of the MM from the MMS User Agent A to the MMS Relay/Server A the MMS Service Provider A uses a control unit to first evaluate the header fields of the received MM or of the WAP message M-Send.req respectively. if—as in the example given here:—header field ‘X Ws-Add-Element’ is present, the MM is completed with the audio file required by the sender by the MMS Service Provider A by appending the file, with the file being referenced via the URI and the header field 192 “X-Mffs-Add-Element” preferably deleted again. Subsequently the MM, which now contains the file itself, instead of the reference to it, is forwarded to the recipient's MMS Relay/Server B via the IP-network (IP—Internet Protocol). Further transmission of the MM to the recipient occurs according to the prior art, i.e. in the WAP message M-Retrieve.conf according to the Figure an MM consisting of two MM elements is delivered to MMS User Agent B: the text and the melody selected by user A.

The WAP message M-Retrieve.conf according to the example given above appears as follows.

M-Retrieve.conf (MMS Relay/Server B→MMS User Agent B)

X-Mms-Message-Type: m-retrieve-conf

X-Mms-TRANSACTION-ID: TRANSACTION-ID#3

X-Mms-Version: 1.0

Date: Wed, 28 Feb. 2001 10:48:32+0100

From: andreas.xxx@xxx.de

To: markus.yyy@zzz.de

X-Mms-Message-ID: MESSAGE-ID#1

Subject: Birthday greetings

X-Mms-Delivery-Report: Yes

Content-Type: Application/vnd.wap.multipart.mixed

nEntries: 2

HeadersLen: XX

DataLen: XX

Content-Type: text/plain;

Hello Markus,

Here is a little tune to wish you all the best for your birthday.

Best wishes, Andreas.

HeadersLen: XX

DataLen: 82345

Content-Type: audio/mp3,

. . .

Instead of appending the said file in the send-side MMS Service Provider it is also advantageously possible to only append the file in the recipient-side MMS Service Provider, provided the latter has the option of such access. in a further alternative the file can also be located at another storage location from which the send and/or recipient-side MMS Service Provider calls up the file so that subsequently the file can be appended to the said message.

The recipient will either—in accordance with the previously described invention variant—transfer the complete message or the recipient will be given the option of choosing what to do with the file. To this end he will be notified by the recipient-side MMS Relay Server that a file is ready for him at the storage location. Such a notification can for example occur in the case of WAP architecture by means of the WAP message M-Notification.ind. With one alternative the recipient will be notified together with the sent message (but without the file) about the presence of the file.

Preferably the recipient receives additional information about the file, for example its name, its size and its file format. Advantageously the recipient can then request via the send/receive application whether the file referenced in the pointer is to be downloaded or not. Other options of dealing with the file are preferably opening the file at its current location and/or forwarding to another storage location, including forwarding to another send/receive application. All these actions require that the recipient-side MMS Relay/Server and the recipient-side send/receive application to support detailed notification of the additional file information. The request for one or more of the above-mentioned actions is preferably implemented via a message sent from the send/receive application to the recipient-side MMS Relay/Server. In the case of a download of the file to the send/receive application the recipient can preferably chose whether the file is to be integrated into the part of the message received in accordance with the prior art or be stored separately by the latter, if the send/receive application supports this process.

The invention cannot just be used for sending MMs by means of WAP messages, but also with future send and receive processes, especially UMTS (Universal Mobile Telecommunication System).

1. Method for handling a message (MM) with multimedia reference in a send application or send/receive application (MMS User Agent A, MMS User Agent B), which is implemented in a mobile radio device or on a device connected to a mobile radio device, characterized in that the message (MM) is generated and/or sent in such as way that at least one reference contained in a specification block also sent to at least one file is included which is stored in memory outside the mobile radio device or on a device connected to the mobile radio device.

2. Method according to claim 1, characterized in that at least one reference is implemented in a header field of the specification block.

3. Method according to claim 1 or 2, characterized in that at least one reference contains a URI (Universal Resource Identifier).

4. Method in accordance with one of the previous claims, characterized in that the message with multimedia reference is sent with WAP message M-Send.req from the send application (MMS User Agent A) to the sender-side MMS relay/server (MMS Relay/Server A), with the WAP message M-Send.req containing at least one header field (“X-Mms-Add-Element”) with the at least one reference.

5. Method in accordance with one of the previous claims, characterized in that the at least one reference is directed to at least one file which is stored in the area of responsibility of the sender-side MMS Service Provider (MMS Service Provider A), of the recipient-side MMS Service Provider (MMS Service Provider B) and/or in an external data memory with access facilities for the sender and/or recipient-side MMS Service Provider (MMS Service Provider A, MMS Service Provider B)

6. Method in accordance with one of the previous claims, characterized in that the field name of the.header field (X-1 ms-Add-Element”) bears the hexadecimal value 0x89.

7. Method in accordance with one of the previous claims, characterized in that the field value or field values of the header field (“X-Mms-Add-Element”) is or are coded as text strings.

8. Method for handling a message (MM) with multimedia reference, which, according to one of the previous claims, was sent by a send application or send/receive application (MMS User Agent A, MMS User Agent B) and was received by a provider network element (MMS Relay/Server A, MMS Relay/Server B), with the specification block sent with the message being evaluated in the sender and/or recipient-side MMS Service Provider: (MMS Service Provider: A, MMS Service Provider: B) with regard to the at least one reference to the at least one file.

9. Method according to claim 8, characterized in that the evaluation with regard to a reference to the at least one file is undertaken via the URI of the file.

10. Method according to claim 8 or 9, characterized in that, the recipient-side MMS Relay/Server (MMS Relay/Server B) notifies the send/receive application (MMS User Agent B) about the at least one file referenced in the at least one reference, preferably inclusive of its characteristic file attributes.

11. Method according to claim 10, characterized in that the notification is undertaken by means of the WAP message M-Notification.ind.

12. Method according to one of claims 8 to 11, characterized in that the recipient-side MMS Relay/Server (MMS Relay/Server B) causes the file referenced in the reference, at the request of the recipient. who has previously received a detailed notification in accordance with claim 10 or 11, to be subjected to at least one of the following actions:
opening the file at its current storage location,
Forwarding the file to another storage location,
Delivering the file (downloading) to the send/receive application (MMS User Agent B),
Integrating the file into the message with the multimedia reference.

13. Method according to one of claims 8 to 12 characterized in that the header field (“X-Mms-Add-Element”) is deleted after successful execution of the job at the send-side MMS Relay/Server (MMS Relay/Server A) or at the recipient-side MMS Relay/Server (MMS Relay/Server B).

14. Device with means for generating, sending, receiving and/or processing messages (MM) with multimedia reference, characterized in that, that the messages can be generated, sent, received and/or processed in such a way, especially according to a method given in one of the previous claims, that they comprise at least one reference included in a specification block, especially a header field, to at least one file, especially in the form of a URI (Universal Resource Identifier).

15. Arrangement in accordance with claim 14, characterized in that it is designed as a telecommunications device, especially a mobile radio device and/or a device connected to a mobile radio device and especially for execution of one or more of the procedure steps according to one of the claims 1 to 7, with the file being stored in a memory outside this device.

16. Arrangement in accordance with claim 14, characterized in that it is designed as a network element in the area of an MMS Service Provider (MMS Service Provider A, MMS Service Provider: B), especially for execution of one or more of the procedure steps according to one of the claims 8 to 13.

17. Software program which can run on a device, especially a device in accordance with one of the claims 14 to 16 in such a way that said software program, together with the device, executes the procedure steps in accordance with one of the claims 1 to 13.

18. Software program which can be loaded onto a device, especially a device in accordance with one of the claims 14 to 16, so that the device programmed in this way is capable or can be adapted to execute the procedure steps according to one of the claims 1 to 13.

19. Software program product which comprises a processor-readable storage medium on which a program is stored, which allows a device, especially a device in accordance with one of claims 14 to 16, after it has been loaded, to execute the procedure steps in accordance with claims 1 to 13.
